(19) United States
(12) Patent Application Publication
(10) Pub. No.: US 2025/0158485 A1
(43) Pub. Date: May 15, 2025

(54) IN-WHEEL ELECTRIC GENERATOR APPARATUS

(71) Applicant: Consolidated Metco, Inc., Vancouver, WA (US)

(72) Inventors: Jeff Larson, Vancouver, WA (US); Bryan Williams, Camas, WA (US); Michael Miga, Portland, OR (US); Joseph Johann Emery, Vancouver, WA (US); Wesley Thomas Morris, Ridgefield, WA (US); Gerrit Jan Kwintenberg, Apeldoorn (NL); Adrianus Petrus Maria Jonker, Doorwerth (NL); Timothy van Seventer, Arnhem (NL); Yang Tang, Apeldoorn (NL)

(21) Appl. No.: 18/938,554

(22) Filed: Nov. 6, 2024

Related U.S. Application Data
(60) Provisional application No. 63/548,122, filed on Nov. 10, 2023.

(51) Int. Cl. H02K 7/18; B60B 27/02; B60B 35/04; B60R 16/03; H02K 1/20; H02K 1/27

(52) U.S. Cl. CPC H02K 7/1846; B60B 27/02; B60B 35/04; B60R 16/03; H02K 1/20; H02K 1/27

(57) ABSTRACT

In one aspect, an in-wheel electric generator apparatus is provided for a vehicle having a wheel hub rotatably mounted to a non-rotatable spindle of the vehicle. The wheel hub has an outboard end portion and a wheel mounting flange inboard of the outboard end portion. The in-wheel electric generator apparatus includes a stator configured to be connected to the spindle so that the stator is outboard of the spindle. The in-wheel electric generator apparatus further includes a rotor configured to be connected to the outboard end portion of the wheel hub so that the rotor is outboard of the wheel hub and spaced outboard from the wheel mounting flange. The rotor is configured to rotate at the same speed as the wheel hub with the wheel connected to the outboard end portion of the wheel hub.

### CROSS-REFERENCE TO RELATED APPLICATION

This application claims the benefit of U.S. Provisional Application No. 63/548,122 filed Nov. 10, 2023, which is incorporated herein by reference in its entirety.

### TECHNICAL FIELD

This disclosure relates to electrical generators for vehicles and, in particular, electrical generators that utilize the rotation of wheels of vehicles to generate energy for use by the vehicles.

### BACKGROUND

Some vehicles include regenerative braking systems that use an electric generator, e.g., an electric motor, to aid in slowing the vehicle and to generate electricity from the rotational motion of one or more wheels of the vehicle. The generated electrical power may be used to charge a battery of the vehicle and/or power one or more components of the vehicle.

Some regenerative braking systems include an electric generator connected to a wheel hub of a vehicle. The electric generator is installed inboard (e.g., toward the body of the vehicle) of the wheel mounted to the wheel hub to permit the wheel to be removed, such as if the wheel gets a flat tire. These types of electric generators may be difficult to retrofit onto an existing vehicle, since there may not be sufficient space and/or mounting locations inboard of the wheel to accommodate the electric generator.

### SUMMARY

In one aspect of the present disclosure, an in-wheel electric generator apparatus is provided for a vehicle having a wheel hub rotatably mounted to a non-rotatable spindle of the vehicle. The wheel hub has an outboard end portion and a wheel mounting flange inboard of the outboard end portion. The in-wheel electric generator apparatus includes a stator configured to be connected to the spindle so that the stator is outboard of the spindle. The in-wheel electric generator apparatus further includes a rotor configured to be connected to the outboard end portion of the wheel hub so that the rotor is outboard of the wheel hub and spaced outboard from the wheel mounting flange. The rotor is configured to rotate at the same speed as the wheel hub with the wheel connected to the outboard end portion of the wheel hub. Because the rotor rotates at the same speed as the wheel hub, the in-wheel electric generator apparatus can utilize the rotation of the rotor and wheel hub to generate electrical power without a gearbox connecting the rotor and wheel hub. Omitting a gearbox may reduce weight and simplify installation and service of the in-wheel electric generator apparatus.

In one embodiment, the rotor includes a wheel hub interface having fasteners configured to extend inboard from the rotor and into threaded axial bores of the wheel hub outboard end portion and connect the rotor to the outboard end portion of the wheel hub. The threaded axial bores of the wheel hub may be formed in an outboard end of a barrel of the wheel hub. In this manner, the fasteners extend axially in the material of the barrel of the wheel hub and provide a compact, strong connection between the rotor and the wheel hub.

The present disclosure also provides an in-wheel electric generator apparatus for a vehicle having a wheel hub rotatably mounted to a non-rotatable spindle of the vehicle. The in-wheel electric generator apparatus includes a stator, a rotor, and a wheel hub interface of the rotor. The stator is configured to be connected to the spindle so that the stator is outboard of the spindle. The wheel hub interface is configured to releasably connect the rotor to the wheel hub and position the rotor outboard of the wheel hub so that the rotor rotates at the same speed as the wheel hub during movement of the vehicle. Further, the wheel hub interface is configured to releasably connect to the wheel hub outboard of the wheel hub mounting flange to permit removal of the rotor from the wheel hub while a wheel is mounted to the wheel hub mounting flange.

### BRIEF DESCRIPTION OF DRAWINGS

FIG. 1A is a perspective view of an electric generator apparatus mounted to a wheel hub assembly and a spindle of a vehicle

FIG. 1B is a perspective view of the electric generator apparatus of FIG. 1A removed from the wheel hub assembly and the spindle

FIG. 2 is a perspective view of a vehicle including a tractor and a trailer, the trailer having wheel ends that each include one of the electric generators of FIG. 1A.

FIG. 3 is a perspective, exploded view of an electric generator of the electric generator apparatus of FIG. 1.

FIG. 4A is a cross-sectional view of the electric generator apparatus of FIG. 1A taken along line 4A-4A of FIG. 1A.

FIG. 4B is a cross-section view of the electric generator apparatus of FIG. 1A taken along line 4B-4B of FIG. 1A.

FIG. 4C is a side, elevational view of the electric generator of the electric generator apparatus of FIG. 1A and a rim of a wheel mounted to the wheel hub assembly, FIG. 4C showing the rim mounted to the wheel hub assembly via studs and nuts disposed about the electric generator.

FIG. 5A is a perspective, partially exploded view of the electric generator apparatus, wheel hub assembly, and spindle of FIG. 1A from outboard of the wheel hub assembly.

FIG. 5B is a perspective, partially exploded view of the electric generator apparatus, wheel hub assembly, and spindle of FIG. 1A from inboard of the wheel hub assembly.

FIG. 5C is a perspective view of the electric generator of the electric generator apparatus of FIG. 1A, FIG. 5C showing an outboard connector body of the electric generator.

FIG. 5D is a perspective view of an inboard connector body of the electric generator apparatus of FIG. 1A that is mounted to the spindle and is configured to connect to the outboard connector body of FIG. 5C when the electric generator is mounted to the spindle.

FIG. 6A is a perspective view of a generator adapter of the electric generator apparatus of FIG. 1A, FIG. 6A taken from an outboard side of the generator adapter.

FIG. 6B is a perspective view of the generator adapter of FIG. 6A, FIG. 6B taken from an inboard side of the generator adapter.

FIG. 7A is a perspective view of a stator interface of the electric generator apparatus of FIG. 1A, FIG. 7A taken from an outboard side of the stator interface.

FIG. 7B is a perspective view of the stator interface of FIG. 7A, FIG. 7B taken from an inboard side of the stator interface.

FIG. 8A is a perspective view of a seal body of the electric generator apparatus of FIG. 1A for sealing between the stator interface and the spindle, FIG. 8A taken from an outboard side of the seal body.

FIG. 8B is a perspective view of the seal body of FIG. 8A, FIG. 8B taken from an inboard side of the seal body.

FIG. 9A is a perspective view of a seal body of the electric generator apparatus of FIG. 1A for sealing between the stator interface and the generator adapter.

FIG. 9B is a cross-section of the seal body of FIG. 9A taken along line 9B-9B in FIG. 9A.

FIG. 10A is a perspective view of the electric generator of the electric generator apparatus of FIG. 1A detached from the wheel hub assembly, FIG. 10A taken from an outboard side of the wheel hub assembly.

FIG. 10B is a perspective view of the electric generator detached from the wheel hub assembly as in FIG. 10A, FIG. 10B taken from an inboard side of the wheel hub assembly.

FIG. 11 is a perspective view of the electric generator apparatus and the spindle of FIG. 1A with the wheel end assembly removed to show the connection between the electric generator and the spindle.

FIG. 12 is a schematic diagram of the electric generator apparatus of FIG. 1A in communication with components of the vehicle.

FIG. 13 is a perspective view of an electrical and cooling connector assembly including an inboard connector body with associated cables for connecting to the vehicle according to another embodiment.

FIG. 14 is a cross-section view of the electric generator apparatus of FIG. 1A including the inboard connector body of FIG. 13, FIG. 14 showing the cables extending through the axle of the vehicle.

FIG. 15A is a perspective view of a spacer for the electrical and cooling connector assembly of FIG. 13 according to another embodiment.

FIG. 15B is a side view of the spacer of FIG. 15A.

FIG. 16 is a cross-section view of an electric generator apparatus according to another embodiment, the electric generator apparatus including a seal positioned between the rotor housing and the stator interface body.

### DETAILED DESCRIPTION

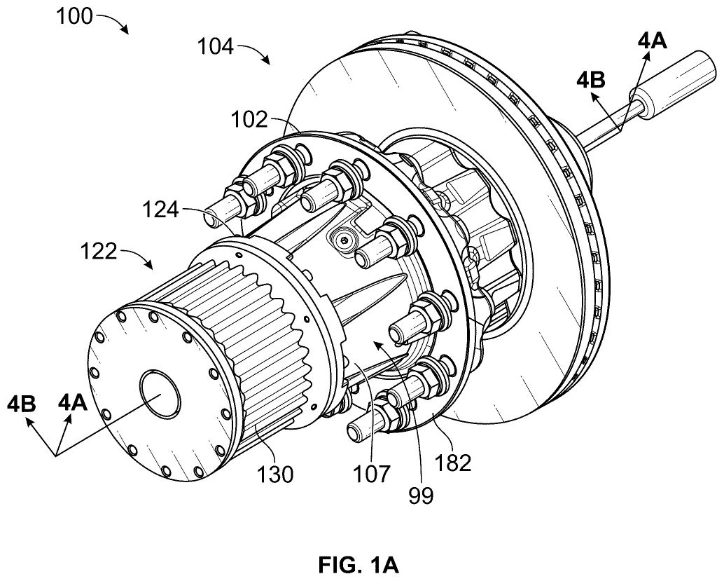

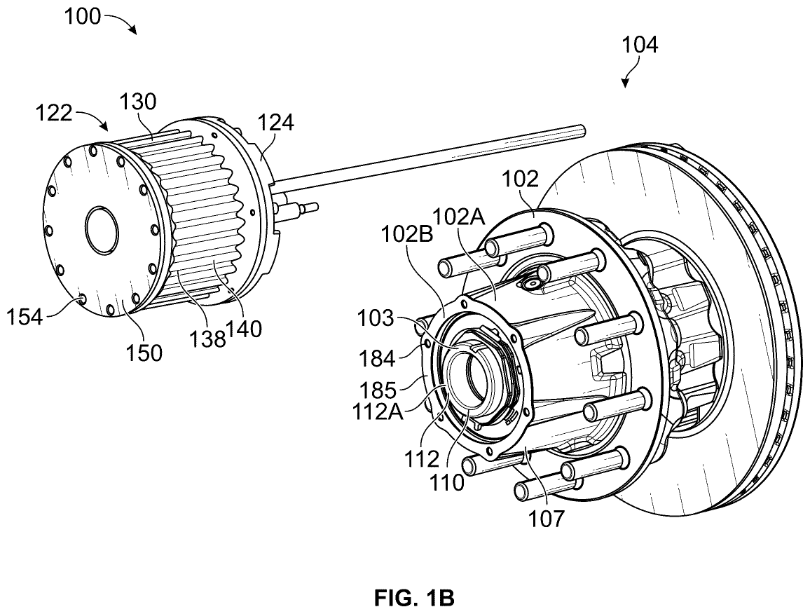

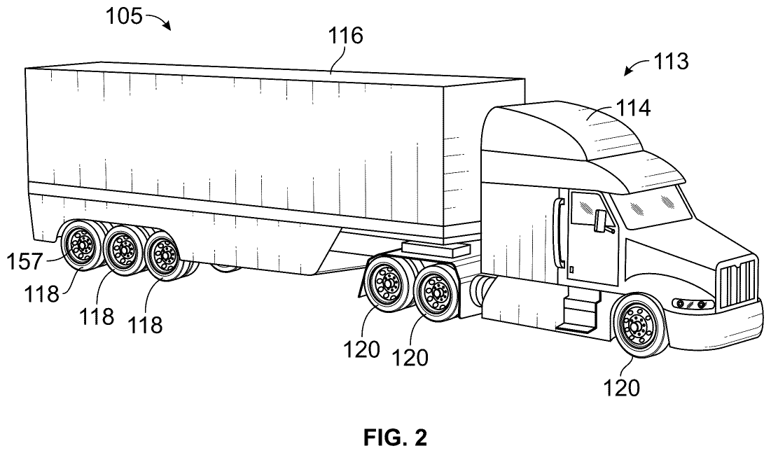

With respect to FIGS. 1A-1B, an electric generator apparatus 100 is provided that is configured to be connected to and disconnected from a wheel end assembly 104 and axle 103 of a vehicle 105 (see FIG. 2). The electric generator apparatus 100 is connectable to an outboard end portion 107 of a wheel hub 102 of the wheel end assembly 104 and an outboard end portion 112 (see FIG. 1B) of a spindle 110 of the axle 103. The electric generator apparatus 100 may be operated to generate electrical power from the rotational motion of the wheel hub 102 about the spindle 110 as the vehicle 105 moves.

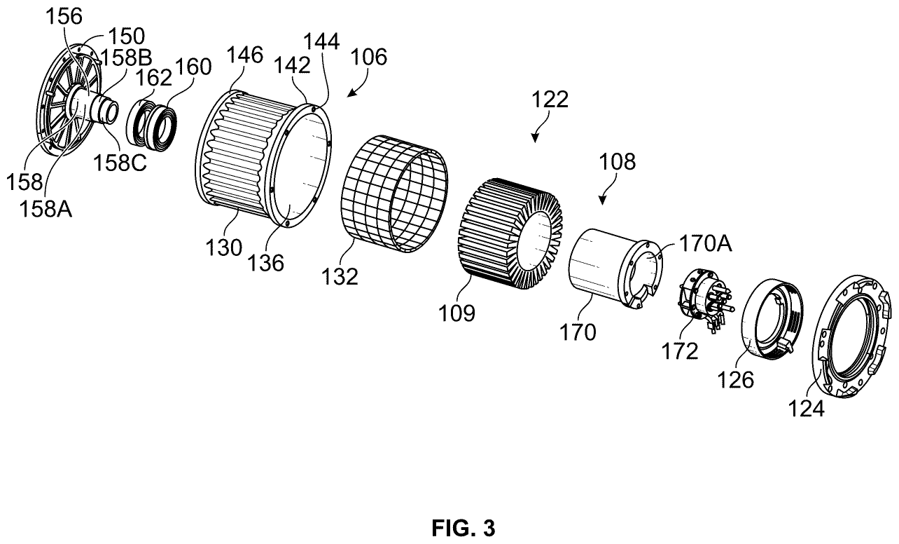

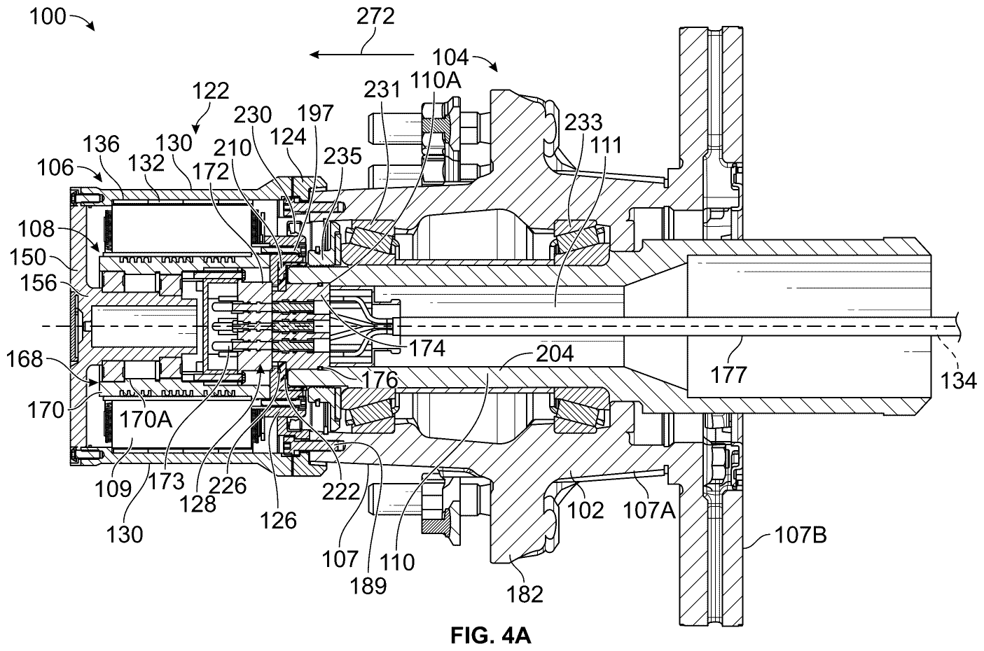

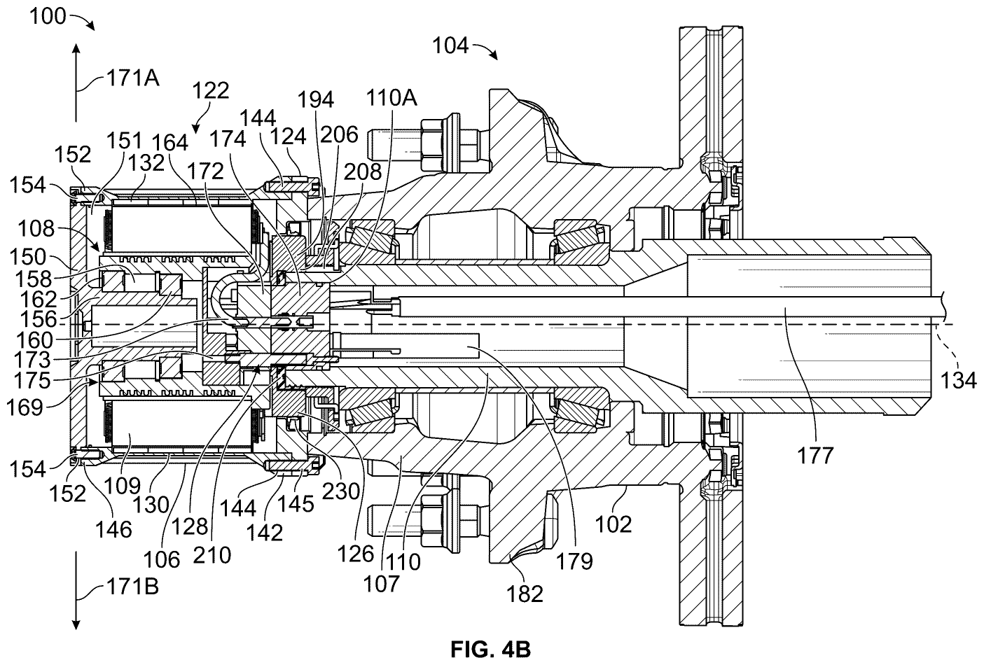

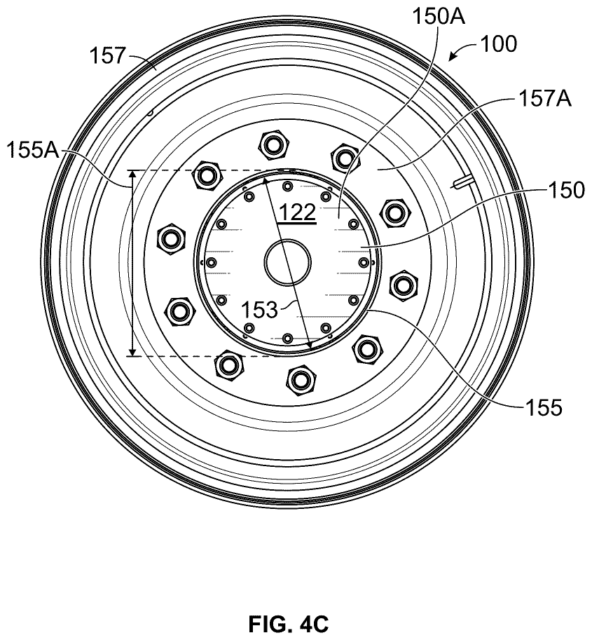

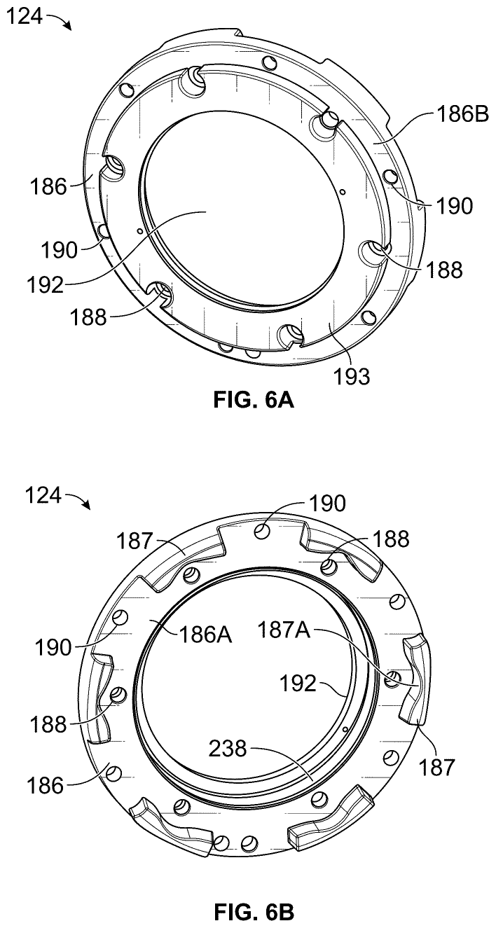

Regarding FIGS. 1A and 3, the electric generator apparatus 100 includes an electric generator 122 with a rotor 106 and a stator 108. The rotor 106 includes a wheel hub interface 99 (see FIG. 1A) configured to releasably connect the electric generator apparatus 100, including the rotor 106, to the wheel hub 102 outboard of a wheel mounting flange 182 of the wheel hub 102. In this manner, the rotor 106 can be connected to or disconnected from the wheel hub 102 while a wheel is mounted to the wheel mounting flange 182. The wheel hub interface 99 includes a generator adapter 124 (see FIG. 3) with a first releasable connection (e.g., fasteners 189 of FIG. 4A) for securing the generator adapter 124 to the wheel hub 102 and a second releasable connection (e.g., fasteners 145 of FIG. 4B) for securing a rotor body 130 (see FIG. 3) to the generator adapter 124. The generator adapter 124 also has a central opening 192 (see FIG. 6A) sized to permit an inboard end of the stator 108 to be advanced therethrough. The generator adapter 124 permits the electric generator 122 to be connected to the wheel hub 102 by securing the generator adapter 124 to the wheel hub 102, sliding the stator 108 into keyed engagement with the spindle 110 via the central opening 192 of the generator adapter 124, and securing the rotor body 130 to the generator adapter 124.

The electric generator apparatus 100 may be installed on the wheel end assembly 104 and axle 103 without disassembly of the wheel end assembly 104 or removal of a wheel mounted to the wheel hub 102. The electric generator apparatus 100 is configured to permit the wheel associated with the wheel end assembly 104 to be removed from the wheel end assembly 104 without removing the electric generator apparatus 100, such as in the event of a flat tire of the wheel. Moreover, the electric generator apparatus 100 may be retrofitted to wheel end assemblies 104 of vehicles 105 that do not have electric generator systems with minor, if any, modifications to the wheel end assembly 104.

With respect to FIG. 2, the vehicle 105 having the electric generator apparatus 100 may be a semi-truck 113 including a tractor 114 and a trailer 116. While the following discussion describes an example embodiment where the electric generator apparatus 100 is coupled to a non-driven wheel 118 of the trailer 116, it will be appreciated that the electric generator apparatus 100 may be utilized with a non-driven wheel 120 of the tractor 114. The electric generator apparatus 100 may be utilized with other types of vehicles including recreational vehicles, camper trailers, utility trailers, agricultural equipment, and tow dollies (e.g., for cars). Moreover, those having skill in the art will readily appreciate that the electric generator apparatus 100 may be mounted to wheel end assemblies of other types of vehicles including, as examples, box trucks, cargo vans, cars, and buses.

With respect to FIG. 3-4C, the electric generator apparatus 100 includes an electric generator 122, a generator adapter 124, a stator interface 126, and an electrical connector 128. The electric generator 122 has a rotor 106 and a stator 108. The rotor 106 is rotatable about the stator 108 to generate electrical power. The stator 108 is configured to form a non-rotatable connection with the spindle 110 of the vehicle 105 in a manner that inhibits to inhibit the stator 108 from turning relative to the spindle 110. The rotor 106 is securable to the wheel hub 102 of the wheel end assembly 104 such that the rotor 106 rotates with the wheel hub 102 and about the stator 108 as the vehicle 105 moves. The electric generator 122 generates electrical power from the rotational motion of the wheel hub 102 about the spindle 110.

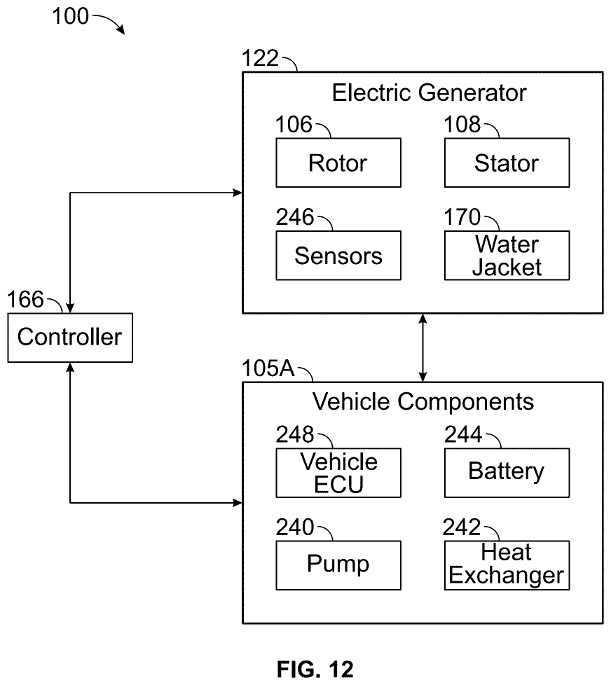

The operation of the electric generator 122 produces a slight braking torque to the wheel hub 102 in a direction opposite the direction of rotation of the wheel hub 102. The torque may be relatively low, such that the operation of the electric generator 122 does not substantively affect acceleration, deceleration, or cruising speed of the vehicle. In other embodiments, the electric generator 122 may be operated to provide sufficient braking torque to supplement the friction brakes of the vehicle 105 and decelerate the vehicle 105. The electric generator 122 has or is in communication with a controller 166 (see FIG. 12), for example, an inverter, that can adjust the electrical energy generated by the electric generator 122 by adjusting the torque the electric generator 122 applies to the wheel hub 102. For example, the electric generator 122 may be configured to apply a constant torque above a predetermined vehicle speed (e.g., highway speed) and no torque below the predetermined vehicle speed (e.g., in-city speeds). In another embodiment, the electric generator 122 applies a variable torque that changes according to vehicle speed, such as applying a torque that maximizes the electrical power generated by the electric generator 122 at a given vehicle speed.

In another embodiment, the electric generator 122 may be operated as a motor to apply a driving torque to the wheel hub 102 in the direction of rotation of the wheel hub 102 to assist the internal combustion engine of the vehicle 105 in moving the vehicle 105. For example, the electric generator 122 may be operated as a motor to apply a driving torque to the wheel hub 102 when the vehicle 105 is driving up an incline to reduce fuel consumption of the internal combustion engine.

Returning to FIG. 3, the rotor 106 includes a rotor body 130 and a plurality of magnets 132 associated with the rotor body 130. The rotor body 130 may be made of a metallic material, for example, iron. The rotor body 130 may be substantially cylindrical and rotatable about an axis of rotation 134 (see FIG. 4A). The magnets 132 may be fixed to an interior surface 136 of the rotor body 130, for example, with fasteners, adhesive, interlocking portions. As another example, the magnets 132 may be molded into the rotor body 130. The magnets 132 may be permanent magnets, for example, iron permanent magnets. Rotation of the rotor body 130 about the axis of rotation 134 rotates the magnets 132 about the stator 108. The rotor body 130 may have a fluted exterior surface 138 (see FIG. 1B) with axial ridges 140 that increase the surface area of the exterior surface 138 for dissipating heat from the rotor 106 to the air surrounding the electric generator 122. In another embodiment, the exterior surface of the rotor body 130 is smooth. With the rotor 106 outboard of the wheel hub 102, movement of the vehicle 105 causes air to flow around the rotor body 130 which aids in cooling the rotor 106. Further, the ridges 140 may create turbulence in the air flowing around the rotor body 130 as the vehicle 105 moves which aids in heat dissipation.

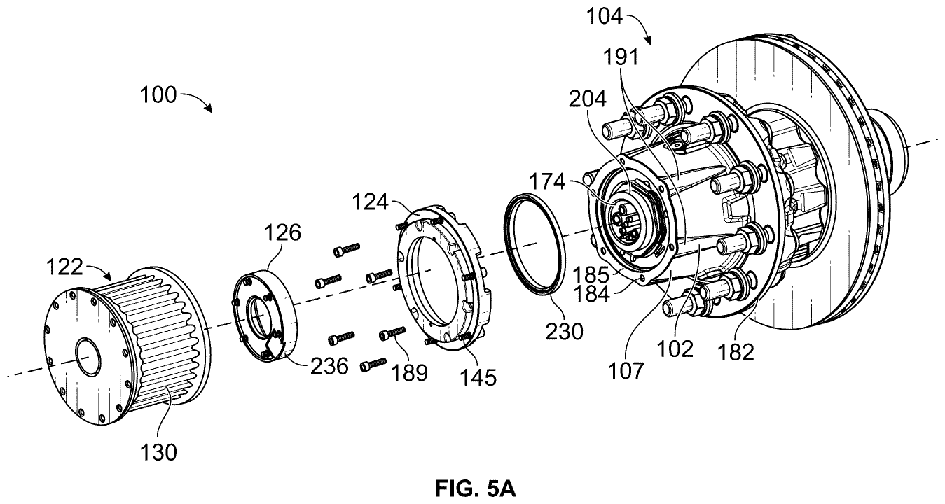

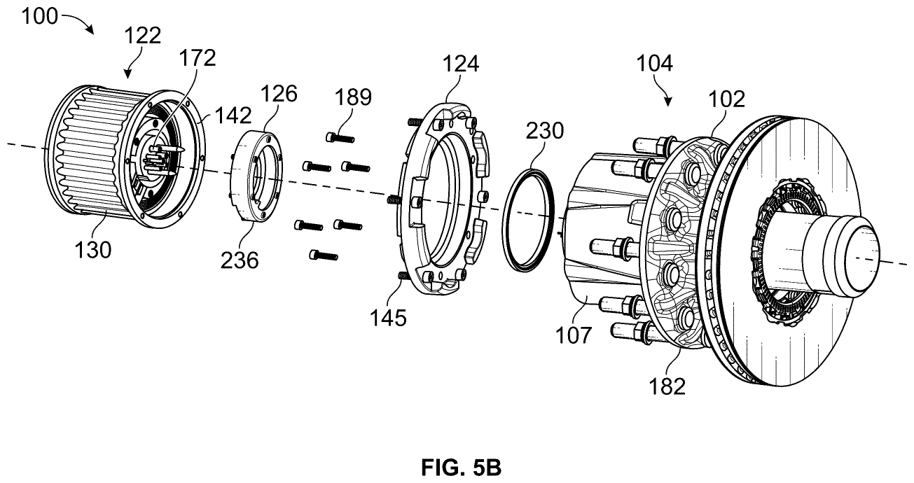

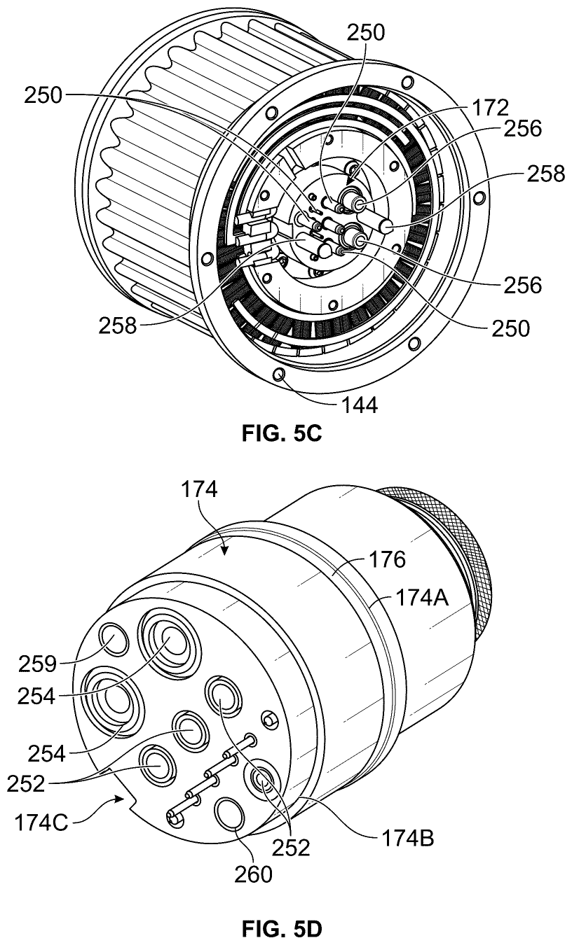

Regarding FIG. 3, the rotor body 130 includes a first end portion 142 for securing to the wheel hub 102 of the wheel end assembly 104. Once the rotor body 130 is secured to the wheel hub 102, the rotor body 130 is fixed to the wheel hub 102 and will rotate at the same rotational velocity as the wheel hub 102 when the vehicle 105 is in motion. The first end portion 142 may include a plurality of attachment holes 144 for receiving fasteners to mount the rotor body 130 to the wheel hub 102. The first end portion 142 may be fixed to the wheel hub 102 by the generator adapter 124 as discussed below (see FIGS. 5A, 5B, 6A, and 6B).

Regarding FIG. 3, the electric generator 122 may include an end cap 150 that covers an end of the rotor body 130 to inhibit fluid and/or debris from entering or exiting the electric generator 122. The rotor body 130 includes a second end portion 146 that includes a plurality of attachment holes 152 (see FIG. 4B). Fasteners 154 extend through the end cap 150 and into the attachment holes 152 of the rotor body 130 to secure the end cap 150 to the rotor body 130. A seal (e.g., a gasket) may be positioned between the end cap 150 and the rotor body 130 to inhibit fluid and/or debris from passing therebetween.

With reference to FIG. 4B, the electric generator 122 includes a support shaft 156 that extends from the end cap 150 into an interior 151 of the electric generator 122. The support shaft 156 may be integral with or connected to the end cap 150. For example, the support shaft 156 may be formed as a single piece with the end cap 150. The end cap 150 and support shaft 156 may be made of a sufficiently rigid material such as a metallic material, for example, aluminum. The second end portion 146 of the rotor body 130 is rigidly coupled to the support shaft 156. For example, the rotor body 130 may be rigidly coupled to the support shaft 156 by way of the connection to the end cap 150 which includes the support shaft 156. The support shaft 156 extends along the axis of rotation 134 of the rotor body 130 and supports the stator 108 in concentric alignment with the rotor 106.

Regarding FIG. 3, the support shaft 156 includes bearing seats, such as an exterior surface 158, that supports radially inner portions of the inboard and outboard bearings 160, 162. To support the radially outer portions of the inboard and outboard bearings 160, 162, the water jacket 170 of the stator 108 has bearing seats such as portions of an interior surface 170A of the water jacket 170. The bearings 160, 162 extend radially between the support shaft 156 and the stator 108 to permit the support shaft 156 to rotate with the rotor body 130 while maintaining the spaced, concentric relationship between the rotor 106 and the stator 108. Regarding FIG. 4B, one of the bearings 160, 162 may be axially fixed between the stator 108 and the support shaft 156 while the other is axially floating to allow for relative axial movement of the support shaft 156 and the stator 108, for example, due to thermal expansion/contraction. For example, the inboard bearing 160 may be fixed and the outboard bearing 162 may be floating. The exterior surface 158 of the support shaft 156 may include a first step profile that transitions from a larger diameter portion 158A (see FIG. 3) to a first small diameter portion 158B and a second step profile that transitions from the first small diameter portion 158B to a second small diameter portion 158C. The large diameter portion 158A has a larger diameter than the first and second small diameter portions 158B, 158C and supports the outboard bearing 162. The first small diameter portion 158B has a larger diameter than the second small diameter portion 158C and supports the inboard bearing 160. A locking collar may be mounted to the second small diameter portion 158C inboard of the inboard bearing 160 to fix the inboard bearing 160 against axial movement relative to the support shaft 156.

Regarding FIG. 4B, the support shaft 156 and the bearings 160, 162 provide a concentrically rigid, outboard connection between the rotor 106 and the stator 108 to fix a radial distance between the rotor 106 and stator 108 and keep the rotor 106 concentrically aligned with the stator 108 even when external forces act on the rotor 106 and/or stator 108. More specifically, the support shaft 156 and bearings 160, 162 rigidly fix the second end portion 146 of the rotor body 130 and an outboard end portion 169 of the stator 108 from moving radially relative to one another such as in directions 171A, 171B. At the same time, the support shaft 156 and bearings 160, 162 permit rotation of the rotor body 130 around the stator 108.

Bending or misalignment of the rotor 106 and the stator 108, for example, due to forces acting on a vehicle axle including the spindle 110, could cause the magnets 132 of the rotor 106 to contact the stator 108 which can cause damage to the electric generator 122. Supporting the stator 108 in concentric alignment with the rotor 106 maintains an air gap 164 (see FIG. 4B) between the magnets 132 of the rotor 106 and the stator 108. By maintaining the rotor 106 in concentric alignment with the stator 108, the radial distance of the air gap 164 may also be minimized to increase the efficiency of the operation of electric generator 122 (e.g., in generating electrical power) without the magnets 132 contacting the stator 108.

Regarding FIG. 3, the stator 108 includes a stator core 109 with stator laminations and copper wire windings about the stator core 109 that electrically interact with the magnets 132 of the rotor 106 to apply a torque to the rotor 106. The stator 108 includes a support, such as the water jacket 170, to support the stator core 109. The stator 108 may be electrically connected to the controller 166 (see FIG. 12) that controls the current in the stator 108 to apply a torque to the rotor 106 in the desired direction, e.g., opposite the direction of rotation of the rotor 106 to generate electrical power or in the direction of rotation of the rotor 106 to provide vehicle propulsion.

Regarding FIG. 4A, the electric generator apparatus 100 may include a fluid cooling system 168 that is operable to cool the stator 108. The fluid cooling system 168 may include one or more fluid pathways, such as one or more conduits or machined-in passages, extending along and/or through the stator 108 to cool the stator 108. In one embodiment, the water jacket 170 has one or more fluid pathways extending through the water jacket 170 adjacent the stator core 109 and windings. The stator windings may be wound about the stator core 109 which is supported on the water jacket 170 such that heat generated by the stator windings is transferred to the coolant traveling through the fluid pathways of the water jacket 170. Coolant may be directed through the one or more fluid pathways of the water jacket 170 to remove heat generated by the stator windings from the water jacket 170 and stator 108. The heated coolant in the water jacket 170 may be directed from the electric generator 122 to a heat exchanger 242 (see FIG. 12) of the fluid cooling system 168 for heat removal, before being recirculated back to the water jacket 170.

With respect to FIG. 4C, the electric generator 122 has a portion 150A outboard of an attachment flange 157A of a rim 157 of the wheel 118 when the wheel 118 is secured to the wheel hub 102. The portion 150A of the electric generator 122 has an outer dimension 153 (e.g., diameter) that is smaller than an inner dimension 155A (e.g., inner diameter) of an opening 155 of the rim 157 of the wheel 118. The portion 150A is sized to fit within the opening 155 of the rim 157 so that the rim 157 may be disconnected from the wheel hub 102 and moved in an outboard direction 272 (see FIG. 4A) along from the electric generator 122 to remove the wheel 118 from the wheel hub 102 without removing the electric generator 122 from the wheel hub 102. The generally cylindrical shape of the portion 150A with the smaller outer dimension 153 thereof permits the opening 155 of the rim 157 with the larger inner dimension 155A thereof to travel along and off of the portion 150A without being caught on or otherwise interfered with by the electric generator 122. Conversely, the rim 157 may be moved in an inboard direction along the electric generator 122 with the opening 155 traveling along the portion 150A to mount the wheel 118 to the wheel hub 102 without removing the electric generator 122 from the wheel hub 102. In this manner, the wheel 118 may be serviced, such as replacing one or more tires of the wheel 118, while the electric generator 122 remains mounted to the wheel hub 102.

With respect to FIGS. 4A-4B and 5C-5D, the electric generator apparatus 100 includes the electrical connector 128 having an outboard connector body 172 and an inboard connector body 174. The outboard connector body 172 and inboard connector body 174 are releasably connectable to one another. The outboard connector body 172 is a component of the electric generator 122. The inboard connector body 174 is installed in the spindle 110 and may be connected to one or more systems of the vehicle 105 such that connecting the outboard connector body 174 of the electric generator 122 to the inboard connector body 174 releasably connects the electric generator 122 to such vehicle systems. Specifically, connecting the outboard connector body 172 to the inboard connector body 174 electrically connects electrical conductors of the outboard connector body 172 with corresponding electrical conductors of the inboard connector body 174. For example, the outboard connector body 172 may include a plurality of pins 250 (see FIG. 5C) and the inboard connector body 174 may include a plurality of corresponding pin sockets 252 (see FIG. 5D) that receive the pins 250 of the outboard connector body 172 when the outboard connector body 172 is connected to the inboard connector body 174. The pins 250 and pin sockets 252 may transfer electrical power and/or communication signals (e.g., control signals, sensor data, interlock loops) between the electric generator 122 and the one or more systems of the vehicle 105, such as battery 244 and/or a vehicle electronic control unit (ECU) 248. In other forms, the inboard connector body 174 includes the pins 250 and the outboard connector body 172 includes the pin sockets 252.

Connecting the outboard connector body 172 to the inboard connector body 174 may also fluidly connect a fluid conduit of the outboard connector body 172 with corresponding fluid conduit of the inboard connector body 174. For example, the inboard connector body 172 may include tube couplers 254 that receive conduits such as tubes 256 of the outboard connector body 174 inserted therein. The tubes 256 and tube couplers 254 may form a fluid tight connection and are operable to transfer coolant from the vehicle 105 to the water jacket 170 to cool the stator 108 and to return the heated fluid to the vehicle 105.

The outboard connector body 172 may also include guide pins 258 that extend beyond the electrical pins 250 or tubes 256. The guide pins 258 of the outboard connector body 172 may be inserted into corresponding guide sockets 259 of the inboard connector body 174 to aid in aligning the outboard connector body 172 with the inboard connector body 174 when connected. Aligning the inboard and outboard connector bodies 172, 174 during connection aids to align the pins 250 and tubes 256 with the corresponding pin sockets 252 or tube couplers 254 to inhibit damage to the pins 250 or tubes 256 during insertion.

The outboard connector body 172 is attached to the stator 108 of the electric generator 122. Conductors, such as wires 173 (see FIG. 4B), extend from the stator 108 to the outboard connector body 172. The outboard connector body 172 may be connected to the inboard connector body 174 to electrically connect the stator 108 to the vehicle 105, for example, to a battery 244 of the vehicle and/or the vehicle ECU 248. Fluid conduit 175 (see FIG. 4B) extends from the water jacket 170 of the stator 108 to the outboard connector body 172. The outboard connector body 172 may be connected to the inboard connector body 174 to fluidly connect a portion of a fluid cooling system 168 in the electric generator 122 to the vehicle 105, for example, to a pump 240 and/or the heat exchanger 242 of the fluid cooling system 168 of the vehicle 105.

The inboard connector body 174 is releasably mounted to the spindle 110. For example, the inboard connector body 174 may be sized to be advanced in an inboard direction into a central bore or interior 111 formed by a tubular wall 204 of the spindle 110 (see FIG. 4A). The inboard connector body 174 has an inboard shoulder 174A (see FIG. 5A) that abuts a stop surface 110A (see FIG. 4A) in the interior 111 of the spindle 110 to limit insertion of the inboard connector body 174 into the spindle 110. The inboard connector body 174 includes an annular sealing member 176 (see FIG. 4A) that engages the spindle 110 to inhibit debris and moisture in the interior 111 from entering the electric generator 122. Regarding FIG. 4A, an electrical wiring harness 177 having conductors, such as wires, extends from the inboard connector body 174 through the interior 111 of the spindle 110 to an electrical system of the vehicle 105, for example the battery 244 and/or vehicle ECU 248. Regarding FIG. 4B, a cooling fluid harness 179 including fluid conduit, such as tubes, extend inboard from the inboard connector body 174 to the pump 240 and/or heat exchanger 242 of the fluid cooling system 168 of the vehicle 105.

With respect to FIGS. 5A-5B, the generator adapter 124 and stator interface 126 of the electric generator apparatus 100 mount the electric generator 122 to the wheel end assembly 104 and spindle 110. The generator adapter 124 secures the rotor body 130 to the outboard end portion 107 of the wheel hub 102. The outboard end portion 107 of the wheel hub 102 is outboard of a wheel mounting portion, such as a wheel mounting flange 182, of the wheel hub 102 to which the rim 157 of the wheel 118 is secured. This permits the electric generator apparatus 100 to be installed on the wheel end assembly 104 without the need to remove the wheel hub 102 from the spindle 110. The outboard end portion 107 of the wheel hub 102 may include threaded holes 184 in an outboard face 185 of the wheel hub 102. The wheel hub 102 has an inboard end portion 107A and a circular brake element, such as a brake rotor 107B, mounted thereto.

With respect to FIGS. 6A-6B, the generator adapter 124 includes a body 186 having wheel hub attachment holes 188 and electric generator attachment holes 190. The body 186 may be made of a metallic material, for example, iron and/or aluminum. Fasteners 189 (see FIG. 4A and 5A) extend through the wheel hub attachment holes 188 of the generator adapter 124 and into the attachment holes 184 of the wheel hub 102 to secure the generator adapter 124 to the wheel hub 102. Fasteners 145 (see FIG. 4B and 5A) extend through the electric generator attachment holes 190 of the generator adapter 124 and into the attachment holes 144 of the rotor body 130 to fix the rotor 106 to the generator adapter 124 and the wheel hub 102. Regarding FIG. 6B, the electric generator attachment holes 190 are radially outward of the outboard end portion 107 of the wheel hub 102 when the generator adapter 124 has been secured to the wheel hub 102.

The process of installing the electric generator 122 onto the wheel end assembly 104 includes positioning the generator adapter 124 against the outboard end portion 107 of the wheel hub 102 and advancing the fasteners 189 into the wheel hub attachment holes 188 to secure the generator adapter 124 to the wheel hub 102. Next, the generator adapter 124 includes a central opening 192 (see FIG. 6A) to permit an installer to connect the stator 108 of the electric generator 122 to the spindle 110 of the vehicle 105 via through the opening 192 as discussed below. The installation process next includes positioning the rotor body 130 against the generator adapter 124 secured to the wheel hub 102 and advancing the fasteners 145 into the electric generator attachment holes 190 of the generator adapter 124 and into the attachment holes 144 of the rotor body 130 to secure the rotor body 130 to the generator adapter 124.

In this manner, the generator adapter 124 facilitates releasably connecting the rotor body 130 to the wheel hub 102 using attachment holes 184 in the outboard face 185 of the wheel hub 102, which extend axially in an annular side wall 102A (see FIG. 1B) of a body 102B of the wheel hub 102. The body 102B may have a unitary, one-piece construction that includes the wheel mounting flange 182 and is manufactured by casting steel or aluminum. The attachment holes 184 are machined into the casting of the body 102B and provide an attachment point while preserving the strength of the side wall 102A. The wheel hub 102 includes an outboard bearing 231 and an inboard bearing 233 to rotatably mount the wheel hub body 102B to the spindle 110 and a spindle lock nut 235 to secure the wheel hub body 102 and outboard and inboard bearings 231, 233 to the spindle 110.

Regarding FIG. 6B, the generator adapter 124 has an inboard side 186A with alignment protrusions 187 that each receive a portion of the circumference of the outboard end portion 107 of the wheel hub 102. The alignment protrusions 187 each have a recess 187A on a radially inward side of the alignment protrusion 187 that is sized and shaped to receive a boss or protrusion 191 (see FIG. 5B) of the wheel hub 102 that includes one of the attachment holes 184 (see FIG. 5A) of the wheel hub 102. The protrusions 191 of the wheel hub 102 extend axially along the wheel hub 102 and provide localized increases in the radial thickness of the side wall 102A of the wheel hub 102 to accommodate the associated attachment hole 184.

The engagement between the alignment protrusions 187 of the generator adapter 124 and the protrusions 191 of the wheel hub 102 ensure the generator adapter 124 is clocked or rotationally positioned correctly relative to the wheel hub 102 so that the wheel hub attachment holes 188 of the generator adapter 124 are aligned with the attachment holes 184 of the wheel hub 102 when the generator adapter 124 is mounted on the outboard end portion 107 of the wheel hub 102. The engagement between the alignment protrusions 187 of the generator adapter 124 and the protrusions 191 of the wheel hub 102 also inhibit the generator adapter 124 from moving radially relative to the wheel hub 102 once the inboard side 186A of the body is mounted on the wheel hub 102.

Regarding FIG. 6A, the generator adapter 124 has an outboard side 186B with a smaller diameter portion 193 sized to be inserted into the first end portion 142 (see FIG. 5B) of the rotor body 130 and form a plug-fit connection therebetween. The plug-fit connection includes engaged, concentric surfaces of the smaller diameter portion 193 of the generator adapter 124 and the rotor body 130 which inhibit the rotor body 130 from shifting radially relative to the generator adapter 124.

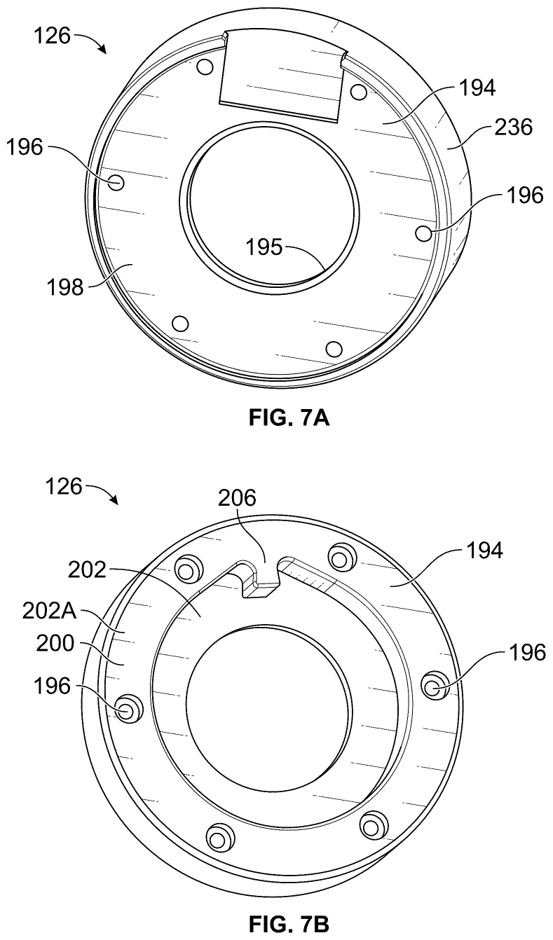

With respect to FIGS. 7A-7B, the stator interface 126 of the electric generator apparatus 100 includes a stator interface body 194 having a plurality of attachment holes 196. The stator interface 126 may be made of a metallic material, for example, aluminum and/or steel. The stator interface 126 includes an opening 195 through which the electrical connector 128 extends. An outboard side 198 of the stator interface 126 faces the stator 108, for example, a support of the stator 108 such as the water jacket 170. The stator interface 126 is fixed to the stator 108 with fasteners 197 (see FIG. 4A) that extend through the attachment holes 196 and into the water jacket 170.

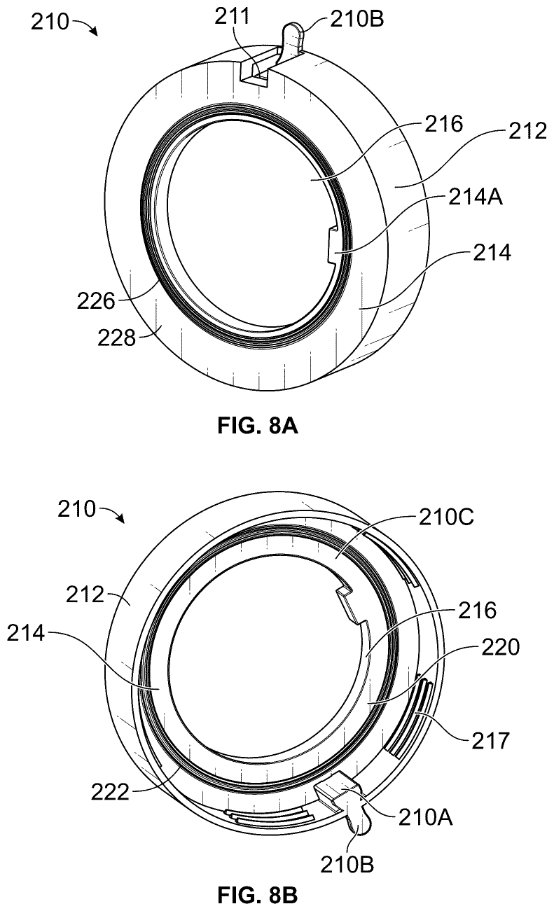

Regarding FIG. 7B, the stator interface 126 has an inboard side 200 with a recess 202 configured to receive a seal body 210 (see FIGS. 8A and 8B) and the outboard end portion 112 of the spindle 110 (see FIG. 4A). The seal body 210 may form a seal between the spindle 110 and the stator interface 126 that inhibits debris and liquids from entering the electric generator 122 as discussed below.

The stator interface 126 further includes a sleeve portion 202A configured to extend substantially concentrically about an axial portion 212 of the seal body 210 and the outboard end portion 112 of the spindle 110. The sleeve portion 202A forms a rigid collar that limits radial movement of the stator interface 126 relative to the outboard end portion 112 of the spindle 110 when the stator interface 126 and seal body 210 are mounted to the spindle 110. The axial portion 212 of the seal body 210, being between the stator interface 126 and the spindle 110, permits some radial movement between the stator interface 126 and spindle 110 because seal body 210 is made of a compressible material, e.g., a thermoplastic elastomer (TPU). Permitting for some play between the stator interface 126 and the spindle 110 accommodates for flexing of the spindle 110, for example, as the vehicle is loaded or unloaded.

As shown in FIG. 7B, the stator interface 126 has a key 206 configured to extend into a keyway 208 (see FIG. 4B) of the spindle 110 and inhibit turning of the stator interface 126 relative to the spindle 110. Turning briefly to FIG. 8B, the seal body 210 is sandwiched between the stator interface 126 and the spindle 110. The seal body 210 may have a channel portion 210A that extends radially inward to fit into the keyway 208 of the spindle 110 when the seal body 210 is initially mounted to the spindle 110. Positioning the channel portion 210A of the seal body 210 in the keyway 208 of the spindle 110 ensures that the seal body 210 is mounted to the spindle 110 in a predetermined rotary orientation.

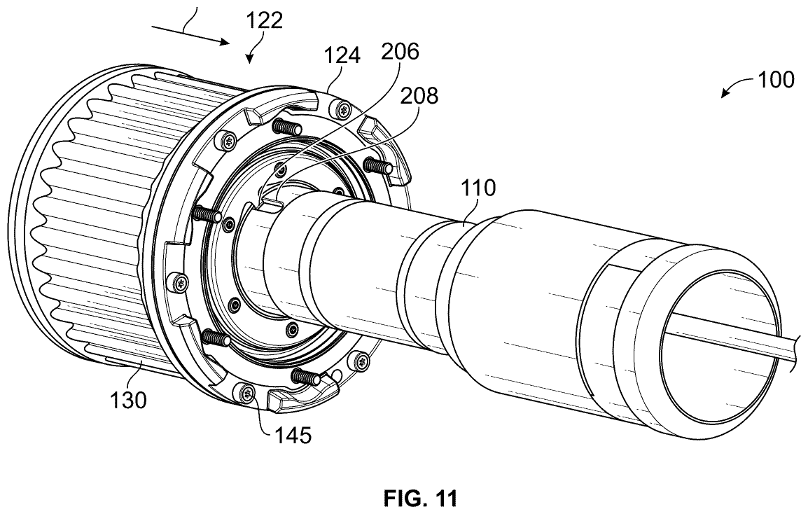

Regarding FIG. 8A, once the seal body 210 has been mounted to the spindle 110, the seal body 210 has a pull tab 210B that may be pulled to remove the pull tab 210B and the channel portion 210A from the remainder of the seal body 210 after the seal body 210. The seal body 210 includes a frangible portion 211 that connects the pull tab 210B and channel portion 210A to the remainder of the seal body 210. The frangible portion 211 tears or breaks when force is applied to remove the pull tab 210B. The frangible portion 211 may include perforations and/or a reduced thickness to facilitate the tearing. Removal of the pull tab 210B and channel portion 210A creates an opening in the seal body 210 through which the key 206 of the stator interface 126 extends when the stator interface 126 is mounted to the spindle 110. Thus, when the stator interface 126 and seal body 210 are assembled onto the spindle 110, the key 206 of the stator interface 126 extends through the opening in the seal body 210 formed by the installer pulling the pull tab 210B and into the keyway 208 of the spindle 110. Regarding FIG. 11, the engagement of the key 206 of the stator interface 126 in the keyway 208 of the spindle 110 forms a non-rotatable connection between the stator interface 126 and the spindle 110 when the stator interface 126 is mounted to the spindle 110. Further, because the channel portion 210A of the seal body 210 was removed by pulling the pull tab 210B, the key 206 extends the full radial depth of the keyway 208 without being limited by the channel portion 210A, which strengthens the connection between the key 206 and the keyway 208 against torque applied to the key 206 by the stator 108.

With respect to FIGS. 8A and 8B, the seal body 210 is annular with an opening 216 through which the electrical connector 128 extends. The seal body 210 has a radial portion 214 extending radially inward from the axial portion 212. The axial portion 212 may be slid onto the outboard end portion 112 of the spindle 110 until the radial portion 214 seats against an outboard end surface 112A (see FIG. 1B) of the spindle 110. The radial portion 214 includes a tab 214A that extends into a notch 174C (see FIG. 5D) of the inboard connector body 174 to inhibit turning of the inboard connector body 174 once the seal body 210 has been mounted to the spindle 110. The axial portion 212 has a radially inner surface with ribs 217 that engage the radially outer surface of the spindle 110 (e.g., threads on the outer surface of the spindle 110) to retain the seal body 210 on the spindle 110.

The radial portion 214 of the seal body 210 is sandwiched between the inboard side 200 of the stator interface 126 and the end of the spindle 110. The seal body 210 has an inboard side 220 with a sealing member 222, such as one or more O-rings, of the radial portion 214 that seals against the outboard end surface 112A (see FIG. 1B) of the spindle 110 when the seal body 210 is mounted thereto. The seal body 210 has outboard side 228 with a sealing member 226, such as one or more O-rings, of the radial portion 214 that seals against the inboard side 200 of the stator interface 126. The sealing members 222, 226 inhibit debris and fluid entering the electric generator 122 (see FIGS. 4A-4B). The sealing members 222, 226 may be made of an elastomeric material, for example, silicone or a rubber. The remainder of the seal body 210 may be made, for example, of a thermoplastic material or a thermoplastic material molded over a steel support.

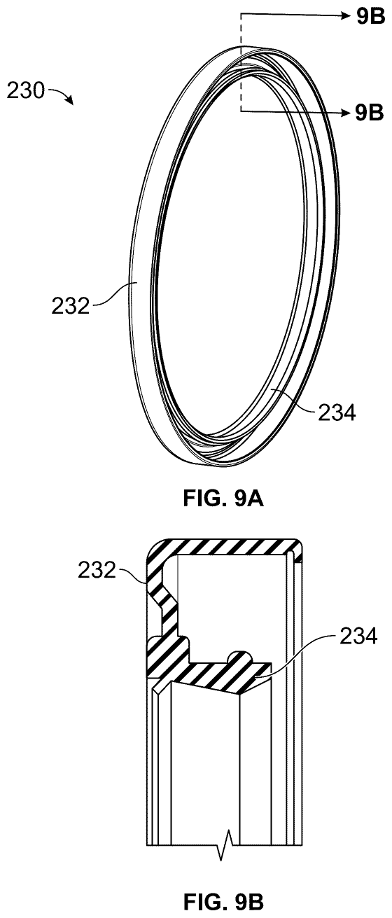

With respect to FIGS. 4A-5B and 9A-9B, the electric generator apparatus 100 includes a seal 230 forming a fluid tight seal between the generator adapter 124 and the stator interface 126. The seal 230 includes a seal body 232 having a sealing portion such as a lip seal 234, and a running surface 236 (see FIG. 7A) of the stator interface 126 that the lip seal 234 engages. The seal body 232 engages an inner surface 238 (see FIG. 6B) of the generator adapter 124. The seal body 232 has an outer diameter that is slightly larger than an inner diameter of the inner surface 238 so that the seal body 232 is secured in the generator adapter 124 via a friction fit connection. The seal body 232 keeps the lip seal 234 in engagement with the running surface 236 when the electric generator apparatus 100 is installed on the vehicle 105. In one embodiment, the running surface 236 is annular with an outer diameter and the lip seal 234 is annular and has an inner diameter slightly smaller than the outer diameter of the running surface 236 such that the lip seal 234 is biased against the running surface 236. The lip seal 234 slidingly engages the running surface 236 and forms a dynamic seal between the lip seal 234 and the stator interface body 194 as the wheel hub 102 rotates during movement of the vehicle 105. The seal 230 forms a fluid tight barrier between the generator adapter 124 and the stator interface 126 to inhibit fluid and debris from entering therebetween. In one embodiment, the lip seal 234 is configured to pump fluid and debris in an inboard direction away from the electric generator 122 as the wheel hub 102 rotates. In another embodiment, the seal body 232 may mount to the stator interface 126 and the generator adapter 124 includes the running surface 236 that is engaged by the lip seal 234. The seal 230 and seal body 210 together inhibit the lubricating fluid of the wheel hub 102 from entering the electric generator 122 and keep the lubricating fluid in the wheel hub 102.

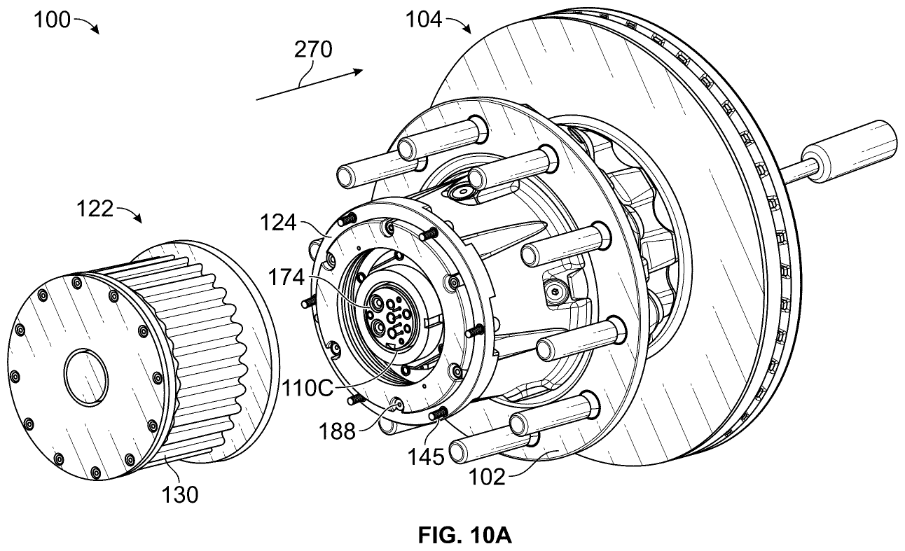

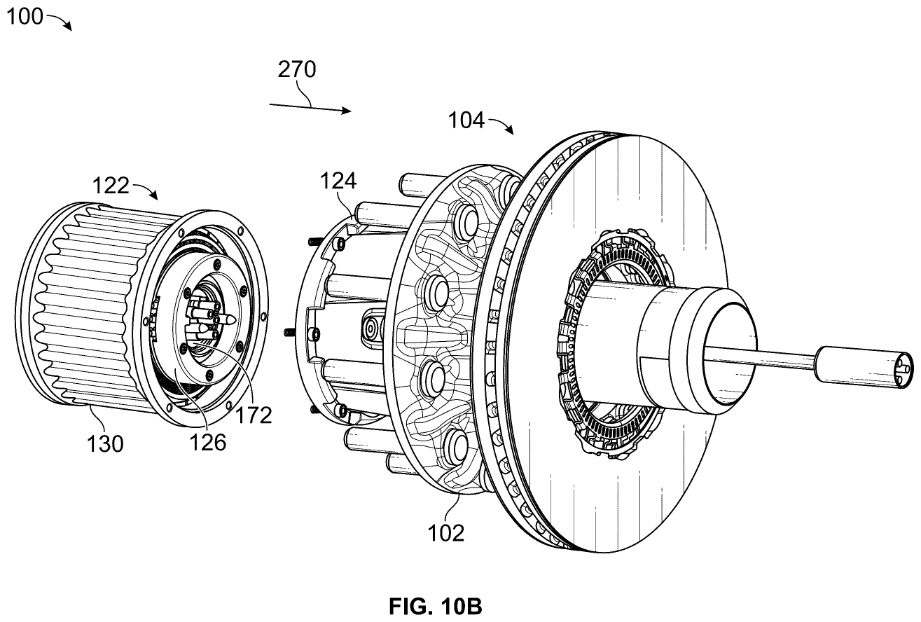

With respect to FIGS. 10A-10B, a process for mounting the electric generator apparatus 100 is provided. Initially, the wires and fluid conduit of the electrical wiring harness 177 and cooling fluid harness 179 are positioned in the interior 111 of the spindle 110 and connected to the electrical and fluid systems of the vehicle 105 such as the battery 244, vehicle ECU 248, pump 240, and/or heat exchanger 242. The inboard connector body 174 is inserted in an inboard direction 270 into an outboard opening 110C of the spindle 110 that opens to the interior 111 of the spindle 110. The inboard connector body 174 may be inserted in the inboard direction 270 into the spindle 110 until the inboard connector body 174 abuts the stop surface 110A in the interior 111 of the spindle 110, which limits the inboard connector body 174 from over-insertion into the spindle 110.

Before or after the inboard connector body 174 is inserted into the spindle 110, the seal body 232 is loaded into the inboard side 186A of the generator adapter 124 and the assembly of the generator adapter 124 and the seal body 232 is secured to the wheel hub 102. The generator adapter 124 is positioned on the wheel hub 102 so that the protrusions 191 of the wheel hub 102 are received in the recesses 187A (see FIG. 6A) of the generator adapter 124. Fasteners 189 are advanced in inboard direction 270 into the wheel hub attachment holes 188 of the generator adapter 124 and the attachment holes 184 of the wheel hub 102 to secure the generator adapter 124 and the seal body 232 therein to the wheel hub 102. A seal, such as a gasket, may also be positioned between the generator adapter 124 and the wheel hub 102 to further resist ingress of debris into the electric generator 122. The fasteners 145 may be positioned in the electric generator attachment holes 190 of the generator adapter 124.

Before or after the generator adapter 124 is secured to the wheel hub 102, the seal body 210 is attached to the outboard end portion 112 of the spindle 110 after the inboard connector body 174 is inserted into the spindle 110. For example, the channel portion 210A of the seal body 210 is aligned with the keyway 208 of the spindle 110 and the seal body 210 is pressed onto the outboard end portion 112 of the spindle 110 until the sealing member 222 (see FIG. 8B) of the seal body 210 seats against the outboard end surface 112A of the spindle 110. The seal body 210 has a rim 210C (see FIG. 8B) that seats against an outboard shoulder 174B (see FIG. 5D) of the inboard connector body 174 to secure the inboard connector body 174 in the spindle 110. The tab 214A is aligned with and inserted into the notch 174C of the outboard connector body 174 to fix the outboard connector body 174 against rotation relative to the seal body 210.

The electric generator 122 is provided assembled as shown in FIG. 10B and mounted to the wheel hub 102. The electric generator 122 has the stator interface 126 secured to the water jacket 170, the outboard connector body 172 secured to the water jacket 170, and the support shaft 156 (see FIG. 4A) received in the inboard and outboard bearings 160, 162. The electric generator 122 is advanced in the inboard direction 270 toward the wheel end assembly 104 to operably connect the outboard connector body 172 with the inboard connector body 174 and mount the stator interface 126 on the spindle 110. The outboard connector body 172 may be connected to the inboard connector body 174 by aligning and inserting electrical pins 250 of the outboard connector body 172 into electrical sockets 252 of the inboard connector body 174. The fluid conduit of the outboard connector body 172 may be connected to the inboard connector body 174 by aligning and inserting the fluid conduit of the outboard connector body 172 into the couplers 254 of the inboard connector body 174. Once the outboard and inboard connector bodies 172, 174 have been operably connected, the outboard and inboard connector bodies 172, 174 facilitate the flow of electricity and fluid between the electric generator 122 and the on-board systems of the vehicle 105 as discussed above.

With reference also to FIG. 11, the process for mounting the electric generator apparatus 100 includes advancing the key 206 of the stator interface 126 in the inboard direction 270 into the opening of the seal body 210 (formed by removing the pull tab 210B and channel portion 210A) and into the keyway 208 of the spindle 110. FIG. 11 has components of the wheel end assembly 104 removed to show the engagement of the key 206 in the keyway 208. Advancing the stator interface 126 of the electric generator 122 in inboard direction 270 onto the spindle 110 also brings the running surface 236 of the stator interface 126 into engagement with the lip seal 234 of the seal 230 in the generator adapter 124.

The rotor body 130 is secured to the generator adapter 124 via the fasteners 145 to fix the rotor body 130 relative to the wheel hub 102 and to secure the electric generator 122 to the wheel end assembly 104. A seal, such as a gasket, may be positioned between the generator adapter 124 and the rotor body 130 to provide a fluid tight connection therebetween. Once the electric generator 122 is mounted to the wheel end assembly 104, rotation of the wheel hub 102 about the spindle 110 causes the rotor 106 of the electric generator 122 to rotate about the stator 108.

With respect to FIG. 12, once installed, the electric generator apparatus 100 is in communication with the vehicle components 105A of the vehicle 105. The electric generator 122 is operable to generate electrical power as the wheel hub 102 rotates about the spindle 110. The generator controller 166 may include a memory (e.g., RAM, ROM) and processor (e.g., a microprocessor or an application specific integrated circuit) configured to control the operation of the electric generator 122. The electric generator 122 may include and house the generator controller 166. Alternatively, the generator controller 166 may be mounted to the vehicle 105 and in communication with the electric generator 122 to control operation of the electric generator 122. The generator controller 166 may communicate with the vehicle 105 to determine how to operate the electric generator 122. The generator controller 166 may communicate with a vehicle ECU 248 of the vehicle 105 that controls operation of the electric generator 122 and any other electric generators 122 mounted at other wheels of the vehicle 105.

The generator controller 166 may receive a torque request or a command to apply a torque to the wheel hub 102. The generator controller 166 is configured to execute the torque command that the generator controller 166 receives, causing the electric generator 122 to apply a torque to the wheel hub 102 to apply a braking or driving force to the vehicle 105. Where a braking force is applied, the electric generator 122 generates electrical power that may be used to charge a battery 244 or to run an electrically powered device of the vehicle 105 (e.g., a refrigerator unit, a communication system, a global navigation satellite system receiver, a powered liftgate, pallet truck charger, hydraulic equipment and/or devices on-board the tractor 114 and/or trailer 116). To apply a braking force, the generator controller 166 may apply and control the current in the stator 108 of the electric generator 122 to electrically interact with the rotor 106 and apply a torque to the wheel hub 102 via the rotor 106 in the direction opposite the direction of rotation of the wheel hub 102. The generator controller 166 induces a magnetic field with the stator 108 by controlling the current in the stator 108. The electric generator 122 may be optimized to operate efficiently (e.g., with the least generator losses) in the range of about 450 RPM to about 850 RPM, which is the rate of rotation for wheels 118, 120 of a semi-truck traveling at highway speeds. The electric generator 122 may be configured to operate efficiently in other ranges of RPMs where the electric generator 122 is associated with a vehicle that frequently travels in another range of speeds. Electrical power generated by the electric generator 122 (e.g., 3-phase AC power) is transferred to the vehicle 105 via the connector 128 and electrical wire harness 177. The electrical power may be used to charge the battery 244 of the vehicle 105 and/or power electrically powered devices of the vehicle 105.

As discussed above, in some embodiments the electric generator 122 may be operated to apply a driving force to the wheel hub 102. To apply the driving force, the generator controller 166 similarly applies and controls the current in the stator 108 to apply a torque to the wheel hub 102 via the rotor 106 in the desired direction of rotation of the wheel hub 102. The electric generator 122 may use electrical power of the battery 244 received through the connector 128 and electrical wire harness 177 to apply the driving torque to the wheel hub 102.

The electric generator 122 may include sensors 246 that monitor operation of the electric generator 122. For example, the sensors 246 may monitor the speed and/or temperature of the electric generator 122. The sensors may sense a temperature of the stator 108 which may be communicated to the vehicle ECU 248 via the electrical connector 128. The vehicle ECU 248 may operate the fluid cooling system 168 to cool the electric generator 122, for example, to inhibit the temperature of the electric generator 122 from exceeding a predetermined temperature. The vehicle ECU 248 may operate the pump 240 to move fluid along fluid conduit extending through the electrical connector 128 and through the water jacket 170 of the stator 108. Heat generated by the stator 108 is transferred to the fluid flowing through the water jacket 170. The heated fluid may be pumped back to the vehicle 105 through the electrical connector 128 and to the heat exchanger 242 where the heat is rejected from the fluid to cool the fluid. The heat exchanger 242 may include, for example, a heat sink and/or a coil of fluid conduit exposed to ambient air to reject heat from the fluid. The cooled fluid may again be cycled through the electric generator 122 to cool the electric generator 122.

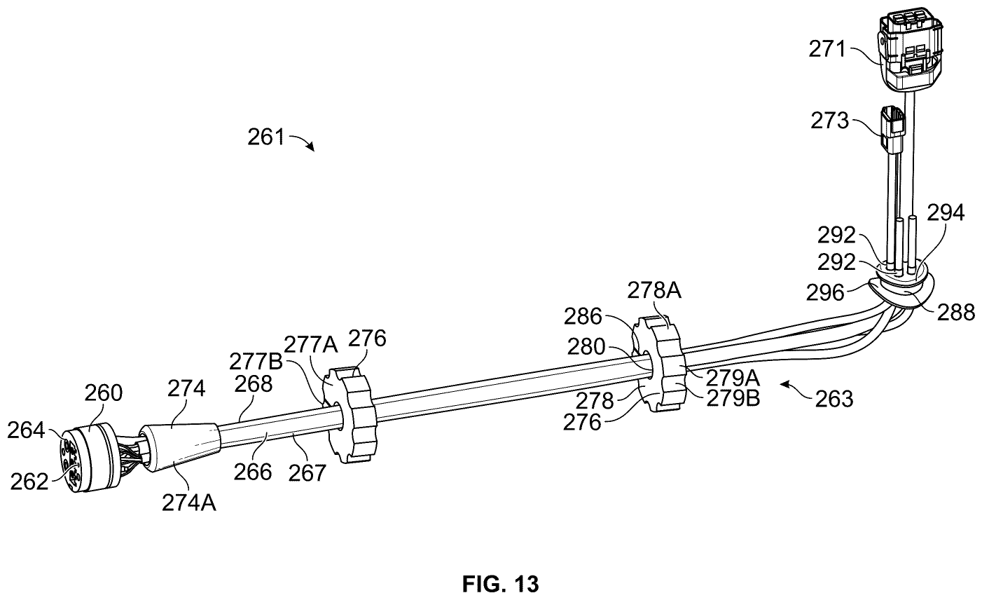

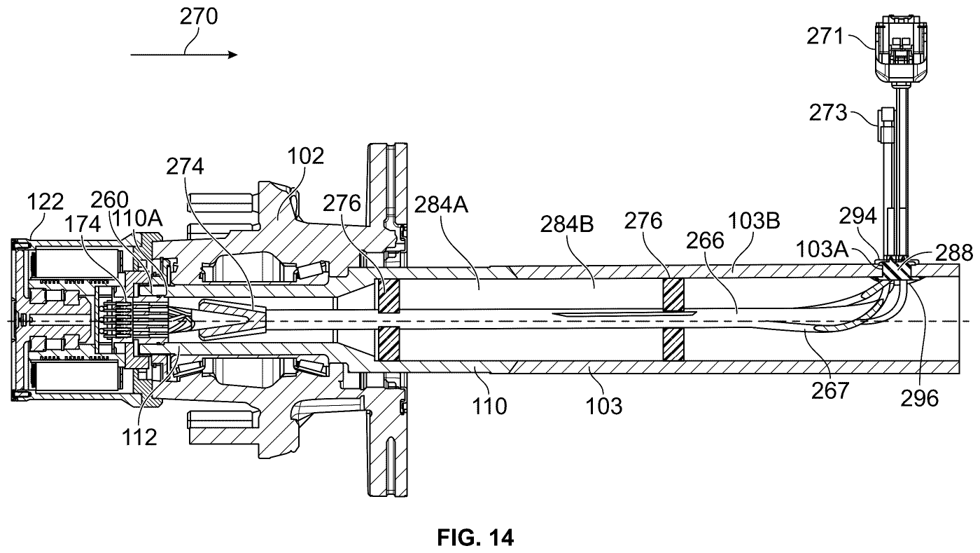

With respect to FIGS. 13-14, an electrical and cooling connector assembly 261 is provided according to another embodiment that includes an inboard connector body 260 and an electrical and cooling harness 263. The inboard connector body 260 is similar in many respects the inboard connector body 174 discussed above such that the differences will be highlighted. The inboard connector body 260 is inserted into the outboard end portion 112 of the spindle 110 and connects to the outboard connector body 172 when the electric generator 122 is mounted to the wheel hub 102. The inboard connector body 260 includes pin sockets 262 and fluid couplers 264 to electrically and fluidically couple the outboard connector body 172 to the inboard connector body 260.

The electrical and cooling harness 263 includes electrical cables 266, 267 attached to the inboard connector body 260 and electrically coupled to the pin sockets 262. The electrical and cooling harness 263 further includes fluid conduits 268 attached to the inboard connector body 260 and fluidly coupled to the fluid couplers 264. The fluid conduits 268 provide coolant from the vehicle to the electric generator apparatus 100 and return heated coolant back to the vehicle. The electrical cables 266, 267 and fluid conduits 268 are routed through the spindle 110 of the axle 103 to be connected to the controller 166 and/or one or more systems of the vehicle 105, such as the battery 244, the vehicle ECU 248, and/or the fluid cooling system 168. The ends of some or all of the electrical cables 266, 267 opposite the inboard connector body 260 may be connected to one or more electrical connectors 271, 273 for connecting to the electrical systems of the vehicle 105. For example, the electrical connectors 271, 273 may be connected to a connector associated with the controller 166. As another example, where the controller 166 is in the electric generator 122, the connector 271 may be connected to the vehicle ECU 248 and the electrical connector 273 may be connected to a connector associated with the battery 244.

The electrical cables 266 and the fluid conduits 268 may be bundled together which may aid in inserting the electrical cables 266, 267 and fluid conduits 268 into the spindle 110. The electrical cables 266, 267 and fluid conduits 268 may be bundled together by a sleeve 274. The sleeve 274 may be positioned near the inboard connector body 260 and inhibit strain on the electrical cables 266, 267 and fluid conduits 268. The sleeve 274 may have a frustoconical outer surface 274A that is narrower at an inboard end thereof to guide the sleeve 274 into the spindle 110 as the sleeve 274 is inserted into the spindle 110. The sleeve 274 may protect the electrical cables 266, 267 and fluid conduits 268 from contacting or getting caught on the spindle 110 during insertion to avoid damaging the electrical cables 266, 267 and/or fluid conduits 268.

The electrical cables 266, 267 and fluid conduits 268 may be bundled together by one or more spacers 276 positioned along the axle 103 as the electrical cables 266, 267 and fluid conduits 268 extend therein. The spacers 276 support the electrical cables 266, 267 and fluid conduits 268 from contacting an interior surface of the spindle 110 and/or the axle 103. Keeping the electrical cables 266, 267 and fluid conduits 268 spaced from the interior surface(s) of the spindle 110 and/or axle 103 inhibits the electrical cables 266, 267 and fluid conduits 268 from rubbing against an interior surface 284A (see FIG. 14) of the spindle 110 and/or an interior surface 284B of the axle 103 (e.g., due to vibrations during operation of the vehicle) and wearing down over time. The spacers 276 each have a body 278 with a central opening 280 for receiving the electrical cables 266, 267 and fluid conduits 268 therethrough. In one embodiment, the body 278 has a split-ring configuration with opposed ends 277A, 277B and a slit 286 separating the ends 277A, 277B that can be urged apart to permit the cables 266, 267 and fluid conduits 268 to be advanced radially into to the central opening 280. Force may be applied to compress the spacers 276 to permit the spacers 276 to be inserted into the spindle 110. The spacers 276 may expand once the force is removed to contact the interior surfaces 284A, 284B of the spindle 110 and axle 103. The periphery 278A of the body 278 may include protrusions 279A spaced apart by recesses 279B. The protrusions 279A/recesses 279B facilitate radial compression of the spacers 276 during assembly into the spindle 110 and subsequent radial expansion of the spacers 276. Regarding FIGS. 13 and 14, the spacers 276 each have a radially outer periphery 278A sized to form an interference fit (when in the expanded state) with the interior surfaces 284A, 284B of the spindle 110 and the axle 103 upon the spacer 276 and the electrical cables 266, 267 and fluid conduits 268 held therein being positioned in the spindle 110 and axle 103.

Regarding FIG. 14, the electrical cables 266 and fluid conduits 268 extend through a grommet 288 of the electrical and cooling connector assembly 261 positioned in a through opening 103A in a side wall 103B of the axle 103. The grommet 288 includes one or more openings 292 (see FIG. 13) through which the electrical cables 266, 267 and fluid conduits 268 extend. The one or more openings 292 are configured to space the electrical cables 266, 267 and fluid conduits 268 from the side wall 103B of the axle 103 to inhibit the electrical cables 266 and fluid conduits 268 from contacting and rubbing against the axle 103. The grommet 288 includes a first flange 294 spaced from a second flange 296. The grommet 288 may be positioned in the opening 103A in a wall 103B of the axle 103 such that the first flange 294 is outside of the axle 103 and the second flange 296 is inside the axle 103 to attach the grommet 288 to the axle 103 and inhibit the grommet 288 from moving relative to the axle 103. The grommet 288 may be made of an elastomeric material (e.g., a rubber and/or silicone). The grommet 288 resists water and debris from entering into the axle 103.

When installing the electrical and cooling connector assembly 261 to the vehicle 105, the connectors 271, 273, inboard ends of the electrical cables 266, 267 and fluid conduits 268, spacers 276, and grommet 288 are advanced in an inboard direction 270 into the outboard end portion 112 of the spindle 110. The connectors 271, 273 and inboard ends of the electrical cables 266, 267 and fluid conduits 268 are routed through the opening 103A in the axle 103 and the grommet 288 is positioned in the opening 103A. The connectors 271, 273 and inboard ends of the electrical cables 266, 267 and fluid conduits 268 are moved away from the opening 103A, e.g., in a radial direction, to take the slack out of the electrical cables 266, 267 and fluid conduits 268 and seat the inboard connector body 260 against the stop surface 110A of the spindle 110. The electrical connectors 271, 273 may be connected to the controller 166, vehicle ECU and/or battery 244 and the fluid conduits 268 connected to the pump 240 and/or heat exchanger 242 of the fluid cooling system 168 such that connecting the outboard connector body 174 of the electric generator 122 electrically and fluidically connects the electric generator 122 to the vehicle 105.

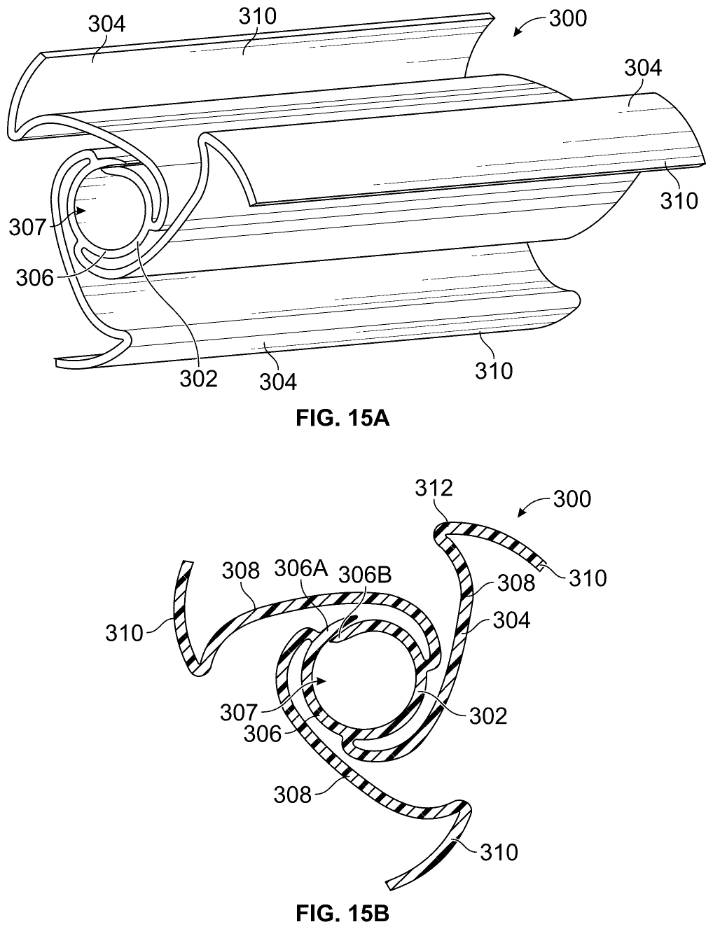

With respect to FIGS. 15A-15B, the electrical and cooling connector assembly 261 may include one or more spacers 300 to be positioned in the spindle 110 and/or axle 103. The spacers 300 bundle the electrical cables 266, 267 and fluid conduits 268 together. The spacers 300 support the electrical cables 266, 267 and fluid conduits 268 from contacting an interior surface of the spindle 110 and/or the axle 103, for example, to inhibit the electrical cables 266, 267 and fluid conduits 268 from contacting and rubbing against the spindle 110 and/or axle 103. The spacers 300 may be used as an alternative to or in addition to the spacers 276 discussed above. The spacers 300 includes an inner, tubular central portion 302 with outwardly extending arm portions 304. The central portion 302 has a central wall 306 extending about an opening 307 for receiving the electrical cables 266, 267 and fluid conduits 268. The wall 306 may have a generally tubular shape about the opening 307. The wall 306 has a split ring configuration with opposing end portions 306A, 306B that overlap with one another. The opposing end portions 306A, 306B may be urged apart from one another to permit the electrical cables 266, 267 and fluid conduits 268 to be advanced radially into to the opening 307. The end portions 306A, 306B may resiliently return to their overlapping configuration once released thereby keeping the electrical cables 266, 267 and fluid conduits 268 in the central portion 302.

The arm portions 304 of the spacer 300 extend outward from the wall 306 to support the wall 306 from the interior surface of the spindle 110 and/or axle 103 when the spacer 300 is inserted therein. The arm portions 304 may be resiliently deformed when positioning the spacer 300 in the spindle 110 and/or axle 103. The arm portions 304 each include an intermediate portion 308 and a contact portion 310. The intermediate portion 308 extends outward from the wall 306 to the contact portion 310. The intermediate portion 308 extends about the wall 306 as the arm portion 304 extends from the wall 306 to the contact portion 310. The contact portion 310 may be arcuate to extend along and complement the tubular interior surface of the spindle 110 and/or axle 103. The contact portion 310 may be connected to the intermediate portion 308 by a bend 312 such that the contact portion 310 extends transversely to the intermediate portion 308. The arm portions 304 may be resiliently deflected in a generally radially inward direction to temporarily decrease the outer diameter of the spacer 300 and permit the spacer 300 to be advanced into the spindle 110 and/or axle 103. Once the spacer 300 has been advanced into the spindle 110 and/or axle 103, the arm portions 304 resiliently bias the contact portions 310 into engagement with the tubular inner surfaces of the spindle 110 and/or axle 103. The bend 312 resiliently deflects and permits the contact portion 310 to extend at different angles relative to the intermediate portion 308 as the arm portions 304 are compressed during installation of the spacer 300. The bends 312 thereby permit the contact portion 310 to face the tubular inner surfaces of the spindle 110 and/or axle 103 even when the arm portions 304 are deflected radially inward.

While the electrical and cooling harness assembly 261 is described as connecting the electric generator 122 to the systems of the vehicle, the electrical and cooling harness assembly 261 may similarly be used to connect other devices mounted to the spindle 110 to systems of the vehicle 105 through the spindle 110 and/or axle 103. For example, the electrical and cooling harness assembly 261 could connect a system of the vehicle 105 to a wheel hub, tire inflation system, and/or another wheel end component. For instance, the electrical and cooling harness 263 may include conduit to connect a pressurized air source of the vehicle to a tire inflation system such as one of the tire inflation systems shown in U.S. patent application Ser. No. 18/235,568, filed Aug. 18, 2023, which is hereby incorporated by reference in its entirety. Moreover, the electrical and cooling harness assembly 261 could additionally or alternatively include conduit for transferring air and/or hydraulic fluid between vehicle systems and devices associated with the spindle 110 and/or axle 103.

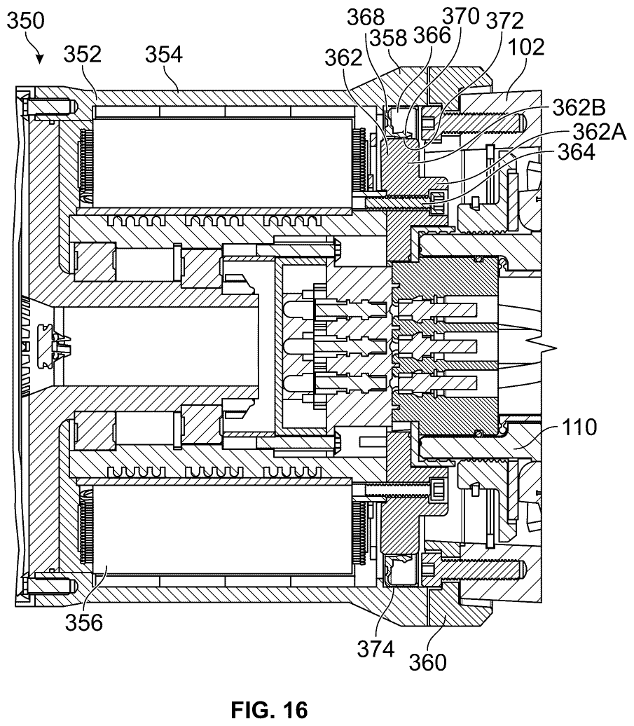

With respect to FIG. 16, an electric generator 350 is provided according to another embodiment. The electric generator 350 is similar in many respects to the electric generator 122 discussed above such that the differences are highlighted. The electric generator 350 includes a rotor 352 having a rotor housing 354 that rotates about a stator 356. The inboard end 358 of the rotor housing 354 is connected to the wheel hub 102 by a generator adapter 360 such that the rotor housing 354 rotates with the wheel hub 102 and about the stator 356 as the vehicle 105 moves. The stator 356 is connected to the spindle 110 of the vehicle 105 by a stator interface 362 to inhibit the stator 356 from rotating relative to the spindle 110. The stator interface 362 is secured to the stator 356, for example, by fasteners 364. The stator interface 362 includes a key that extends into the keyway 208 of the spindle 110 to non-rotatably connect the stator 356 to the spindle 110. The stator interface 362 includes a central portion 362A and an outer portion 362B. The outer portion 362B extends radially outward from the central portion 362A toward the rotor housing 354. The central portion 362A extends axially inboard of the outer portion 362B and is radially inward of the generator adapter 360.

The electric generator 350 includes a seal 366 between the rotor housing 354 and the outer portion 362B of the stator interface 362. The seal 366 has a seal body 368 with a sealing portion such as a lip seal 370 that engages a running surface 372 of the stator interface 362. The seal body 368 is mounted to an inner surface 374 of the rotor housing 354. The seal body 368 has an outer diameter that is slightly larger than an inner diameter of the inner surface 374 so that the seal body 368 is fixed in the rotor housing 354 via a friction fit connection therebetween. The seal body 368 keeps the lip seal 370 in engagement with the running surface 372 of the stator interface 362 to inhibit fluid and/or debris from entering and/or exiting the electric generator 350 regardless of whether the electric generator 350 is installed on the vehicle 105. For instance, the seal 366 keeps lubricant of the wheel hub 102 from entering the electric generator 350 when the electric generator 350 is installed on the vehicle 105. When the electric generator 350 (which includes the stator interface 362) is detached from the vehicle 105, the seal 366 remains in contact with the stator interface 362 to keep the electric generator 350 sealed. In one embodiment, the running surface 372 is annular with an outer diameter and the lip seal 370 is annular and has an initial or undeflected inner diameter slightly smaller than the outer diameter of the running surface 372 such that the lip seal 370 is biased against the running surface 372 during operation of the electric generator 350. The lip seal 370 slidingly engages the running surface 372 and forms a dynamic seal between the lip seal 370 and the stator interface 362 as the rotor housing 354 rotates during movement of the vehicle 105.

The seal 366 may have a variety of forms. In one embodiment, the seal 366 includes two parts. The first part is pressed into the generator adapter (e.g., generator adapter 124) and the second part is pressed into the stator interface 362. One of the two parts has a running surface and the other of the first and second parts has a sealing member engaged with the running surface. The two parts turn relative to one another as the wheel hub 102 rotates.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B.

While there have been illustrated and described particular embodiments of the present invention, it will be appreciated that numerous changes and modifications will occur to those skilled in the art, and it is intended for the present invention to cover all those changes and modifications which fall within the scope of the appended claims.

What is claimed is:

1. An in-wheel electric generator apparatus for a vehicle having a wheel hub rotatably mounted to a non-rotatable spindle of the vehicle, the wheel hub having an outboard end portion and a wheel mounting flange inboard of the outboard end portion, the in-wheel electric generator apparatus comprising:
a stator configured to be connected to the spindle so that the stator is outboard of the spindle; and
a rotor configured to be connected to the outboard end portion of the wheel hub so that the rotor is outboard of the wheel hub and spaced outboard from the wheel mounting flange, the rotor configured to rotate at the same speed as the wheel hub with the rotor connected to the outboard end portion of the wheel hub.

2. The in-wheel electric generator apparatus of claim 1 wherein the rotor includes a wheel hub interface, the wheel hub interface comprising fasteners configured to extend inboard from the rotor and into threaded axial bores of the wheel hub outboard end portion to connect the rotor to the outboard end portion of the wheel hub.

3. The in-wheel electric generator apparatus of claim 1 wherein the rotor is rotatable around an axis relative to the stator; and
wherein the rotor includes at least one magnet spaced axially outboard of the wheel hub with the rotor connected to the wheel hub.

4. The in-wheel electric generator apparatus of claim 1 wherein the rotor comprises a rotor body for rotating around the stator and a generator adapter assembly, the generator adapter assembly having a first releasable connection with the rotor body and a second releasable connection with the wheel hub.

5. The in-wheel electric generator apparatus of claim 1 wherein the rotor comprises a rotor body, a generator adapter for being connected to the rotor body, a first plurality of fasteners, and a second plurality of fasteners;
wherein the first plurality of fasteners extend inboard from the generator adapter and engage the wheel hub with the rotor connected to the wheel hub; and
wherein the second plurality of fasteners extend outboard from the generator adapter and engage the rotor body with the generator adapter connected to the rotor body.

6. The in-wheel electric generator apparatus of claim 1 wherein the rotor comprises a rotor body, a generator adapter, a first plurality of fasteners, and a second plurality of fasteners;
wherein the generator adapter comprises:
a first plurality of through openings to receive the first plurality of fasteners to secure the generator adapter to the wheel hub; and
a second plurality of through openings to receive the second plurality of fasteners to secure the rotor body to the generator adapter.

7. The in-wheel electric generator apparatus of claim 6 wherein the second plurality of through openings are radially outward of the first plurality of through openings.

8. The in-wheel electric generator apparatus of claim 6 wherein the generator adapter includes a central opening to receive a portion of the stator.

9. The in-wheel electric generator apparatus of claim 1 wherein the stator comprises:
stator laminations and metallic windings;
a water jacket supporting the windings; and
a stator interface to connect the water jacket to the spindle, the stator interface having a key to engage a keyway of the spindle.

10. The in-wheel electric generator apparatus of claim 1 wherein the stator comprises:
a stator interface having a key; and
a seal body having an inboard seal to engage the spindle and an outboard seal to engage the stator interface.

11. The in-wheel electric generator apparatus of claim 1 further comprising an electrical and coolant connector having a first connector portion to be mounted to the spindle and a second connector portion to be mounted to the stator, the first and second connector portions configured to be releasably connectable with one another.

12. The in-wheel electric generator apparatus of claim 1 wherein the stator includes a stator interface having a key to extend in a keyway of the spindle;
wherein the rotor includes a generator adapter to connect the rotor to the wheel hub;
a running surface associated with one of the stator interface and the generator adapter; and
a sealing member associated with the other of the stator interface and the generator adapter and engaged with the running surface, the running surface and sealing member configured to rotate relative to one another upon rotation of the wheel hub.

13. The in-wheel electric generator apparatus of claim 1 wherein the rotor includes a rotor body extending about the stator and a support shaft extending in the stator.

14. The in-wheel electric generator apparatus of claim 13 further comprising one or more bearings connecting the support shaft and the stator to permit rotation of the support shaft relative to the stator.

15. The in-wheel electric generator apparatus of claim 13 further comprising bearings connecting the support shaft and the stator and maintaining a radial spacing between the rotor body and the stator.

16. The in-wheel electric generator apparatus of claim 1 in combination with the wheel hub, the wheel hub rotatable around a central axis, the outboard end portion of the wheel hub including an outboard end surface extending perpendicular to and about the central axis;
wherein the wheel hub includes a plurality of threaded axial bores in the outboard end surface; and
wherein the rotor comprises fasteners to engage the threaded axial bores and secure the rotor to the outboard end surface of the wheel hub.

17. The in-wheel electric generator apparatus of claim 1 in combination with the wheel hub, the wheel hub having bosses; and
wherein the rotor includes alignment portions configured to engage the bosses and rotationally align the rotor relative to the wheel hub.

18. The in-wheel electric generator apparatus of claim 1 in combination with the wheel hub, the wheel hub comprising a wheel hub body including the outboard end portion and the wheel hub mounting flange, the wheel hub further comprising outboard and inboard bearings to rotatably mount the wheel hub body to the spindle and a spindle nut to secure the wheel hub body and outboard and inboard bearings to the spindle; and
wherein the stator includes a stator interface having a key to extend in a keyway of the spindle, the stator interface configured to connect the stator to the spindle so that the spindle nut is intermediate the stator interface and the outboard bearing along the spindle.

19. An in-wheel electric generator apparatus for a vehicle having a wheel hub rotatably mounted to a non-rotatable spindle of the vehicle, the wheel hub having an outboard end portion and a wheel mounting flange inboard of the outboard end portion, the in-wheel electric generator apparatus comprising:
a stator configured to be connected to the spindle so that the stator is outboard of the spindle;
a rotor;
a wheel hub interface of the rotor configured to releasably connect the rotor to the wheel hub and position the rotor outboard of the wheel hub so that the rotor rotates at the same speed as the wheel hub during movement of the vehicle; and
the wheel hub interface configured to releasably connect to the wheel hub outboard of the wheel hub mounting flange to permit removal of the rotor from the wheel hub while a wheel is mounted to the wheel hub mounting flange.

20. The in-wheel electric generator apparatus of claim 19 wherein the wheel hub interface includes fasteners configured to extend inboard from the rotor and into threaded axial openings of the wheel hub outboard end portion to connect the rotor to the outboard end portion of the wheel hub.

21. The in-wheel electric generator apparatus of claim 19 wherein the wheel hub interface includes a plurality of fasteners for threadingly engaging the wheel hub.

22. The in-wheel electric generator apparatus of claim 19 wherein the rotor comprises a rotor body for rotating around the stator and the wheel hub interface comprises a generator adapter assembly, the generator adapter assembly having a first releasable connection with the rotor body and a second releasable connection with the wheel hub.

23. The in-wheel electric generator apparatus of claim 19 wherein the rotor comprises a rotor body;
wherein the wheel hub interface comprises a generator adapter for being connected to the rotor body, a first plurality of fasteners, and a second plurality of fasteners;
wherein the first plurality of fasteners extend inboard from the generator adapter and engage the wheel hub with the rotor connected to the wheel hub; and
wherein the second plurality of fasteners extend outboard from the generator adapter and engage the rotor body with the generator adapter connected to the rotor body.

24. The in-wheel electric generator apparatus of claim 19 wherein the rotor comprises a rotor body;
wherein the wheel hub interface comprises a generator adapter, a first plurality of fasteners, and a second plurality of fasteners;
wherein the generator adapter comprises:
a first plurality of through openings to receive the first plurality of fasteners to secure the generator adapter to the wheel hub; and
a second plurality of through openings to receive the second plurality of fasteners to secure the rotor body to the generator adapter.

25. The in-wheel electric generator apparatus of claim 24 wherein the second plurality of through openings are radially outward of the first plurality of through openings.

26. The in-wheel electric generator apparatus of claim 24 wherein the generator adapter includes a central opening to receive a portion of the stator.
